(19) United States
(12) Patent Application Publication
(10) Pub. No.: US 2008/0120150 A1
(43) Pub. Date: May 22, 2008

(54) Processing of Trade Show Information

(75) Inventors: Brendan T. McSheffrey, Newton, MA (US); Kevin Gulley, Newton, MA (US); Christopher Valentine, Marshfield, MA (US)

Correspondence Address: STRATEGIC PATENTS P.C.., C/O PORTFOLIOIP, P.O. BOX 52050, MINNEAPOLIS, MN, 55402, US

(73) Assignee: MAC VENTURES GROUP, INC., Key West, FL (US)

(21) Appl. No.: 11/568,686

(22) PCT Filed: May 2, 2005
(86) PCT No.: PCT/US05/14711

§ 371 Date: Jan. 22, 2008

Related U.S. Application Data
(60) Provisional application No. 60/567,728, filed on May 3, 2004.

(51) Int. Cl. G06Q 10/00

(52) U.S. Cl. 705/7

(57) ABSTRACT

A system determines a level of interest of items at a trade shown (e.g., a trade show exhibit or presentation) based on data about the identity of the items presented at the trade show (e.g., a trade show exhibit or presentation) and information indicating items in which attendees have expressed some interest during the show (e.g., information indicating a person has visited a trade show booth or requested information from a vendor manning a booth).

### TECHNICAL FIELD

This disclosure relates to collection and processing of data collected at a trade show.

### BACKGROUND

In this disclosure the term “trade show” is meant to encompass a trade show, conference, exposition, or similar event at which goods and/or services in an industry or of a company or group of companies are exhibited and/or demonstrated. Additionally, the term “item” or “trade show item” means an exhibitor, exhibit, product, service, advertisement, white paper, presentation, presenter, or other discrete item presented at a trade show.

There are generally three primary participants in a trade show: (i) organizers who plan, organize and run the trade show; (ii) exhibitors who showcase products and/or services at one or more trade show exhibits, and (iii) attendees who attend the trade show. In addition to these three primary participants, a trade show also usually includes presenters who submit publications (e.g., white papers, articles, etc.) and/or make live presentations (e.g., speech, seminar, demonstration, etc.) at a trade show; sponsors who pay the trade show organizer to be recognized as a sponsor of the show and receive prominent advertising space at the show; and advertisers who pay the trade show organizer to place advertisements at the show.

### SUMMARY

In one aspect, the invention features a computer-implemented method for processing data that includes receiving exhibit data indicating the identity of items presented at one or more trade shows, receiving information indicating items in which attendees have expressed some interest during the one or more trade shows, and determining a level of interest of the attendees in one or more of the items based on the information indicating items in which attendees had expressed some interest.

In some embodiments, the items presented at one or more trade shows may be placed into categories and a level of interest in categories of items may be determined based on the information indicating items in which attendees had expressed some interest. Attendee's may express interest in trade show items by bookmarking an item via a handheld device, requesting information about the items via a handheld device, requesting contact from a person associated with the item via a handheld device, providing contact information to a person or company associated with the item via an swipe of an identification badge or via a handheld device, or spending a predetermined amount of time (e.g., 5 minutes) in an area associated with the item (e.g., an exhibit booth).

In another aspect, the invention features a computer-implemented method for processing trade show data that includes receiving item data indicating the identity of one or more selected trade show items among a plurality of a trade show items, receiving attendee data indicating items of interest by one or more selected trade show attendees among a plurality of trade show attendees, correlating the item data according to a predetermined set of exhibit categories, and determining a level of interest of one or more selected trade show attendees among the plurality of trade show attendees in selected one or more elements of the set of categories based on the received trade show attendee data.

The item data and the attendee data may include data from multiple trade shows thus providing an indication of levels of interest in trade show items and categories across multiple shows.

Another aspect of the invention features a computer-implemented method for processing data that includes receiving exhibit data indicating the identity of one or more selected trade show exhibits among a plurality of a trade show exhibits, receiving information indicating trade show exhibits visited by one or more selected trade show attendees among a plurality of trade show attendees during a trade show, correlating the exhibit data according to a predetermined set of exhibit categories, and determining a level of interest of one or more selected trade show attendees among the plurality of trade show attendees in selected one or more elements of the set of categories based on the received trade show attendee data.

Various embodiments may include one or more of the following features. The method may also include receiving attendee identity data indicating the identity of one or more selected trade show attendees among the plurality of a trade show attendees and correlating the attendee identity data according to one or more selected attendee categories among a predetermined set of attendee categories. In an embodiment in which attendee data is correlated into categories, the step of determining a level of interest may include determining a level of interest in one or more selected exhibit categories among the set of exhibit categories based on the correlated attendee data.

The method may also include seminar information indicating seminars attended by one or more selected trade show attendees among the plurality of trade show attendees during a trade show, correlating the seminar information according to one or more selected seminar categories among the predetermined set of seminar categories, and determining a level of interest in one or more selected seminar categories among the set of seminar categories based on the received seminar information indicating seminars attended by one or more selected trade show attendees among the plurality of trade show attendees.

### DESCRIPTION OF DRAWINGS

FIG. 1 is a block diagram showing a method for collecting and processing trade show data.

FIG. 2 is a diagram showing a method of processing data about items that are to be presented at a trade show.

FIG. 3-6 are diagrams of a system for collecting data during a trade show.

FIG. 7 is a diagram of a system for transmitting data to attendees after the completion of a trade show.

FIG. 8 is a diagram of a website showing attendee bookmarks and requested contacts.

FIG. 9 is a diagram of a report produced from data collected during a trade show.

### DETAILED DESCRIPTION

A trade show arguably represents a statistical microcosm of the real market for the products and services exhibited at the trade show. As such, data indicating the level of interest in a particular product or service exhibited or advertised at a trade show (e.g., Allegra® by Aventis Pharmaceuticals Inc.) may be indicative of the future success of the product or service. Additionally, data indicating a level of interest in a category of products, services, and other items presented at a trade show (e.g., LINUX software products, LINUX consulting services, and white papers about LINUX) may be indicative of future success of a particular market segment. Moreover, data indicating the relative level of interest in products, services or in categories in comparison to other products, services or categories provides a basis for rating the popularity of a product, service or category of items presented at a trade show. Demographic information about the attendees (e.g., age, gender, income level, occupation, etc.) who visited particular exhibits, attended educational events or otherwise expressed some interest in various items at a trade show may be used to provide trade show organizers, exhibitors, and others (e.g., market analysts, investors, etc.) with valuable insight into not only how many attendees visited a particular exhibit, attended a particular educational activity, expressed in interest in a particular item, or were interested in a particular category, but also what market segment was interested (or not interested) in that exhibit, educational activity, item or category.

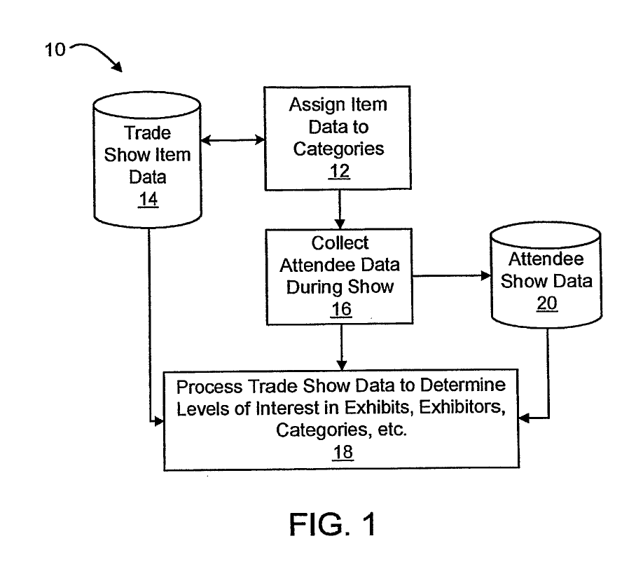

Referring to FIG. 1, a method 10 for collecting and processing trade show data generally includes assigning 12 trade show item data 14 into categories, collecting 16 attendee information during the trade show, and processing 18 the trade show data (e.g., the trade show item data 14 and attendee data 20) during and after the trade show to determine levels of interest in exhibits, exhibitors, products, services, educational opportunities, advertisements, other trade show items, or categories of trade show items.

The trade show item data 14 includes information about items that are to be presented at a trade show, including data about exhibitors and the exhibits they are to present at the show, data about sponsors and advertisers and the advertisements to be presented at the show (e.g., banners, posters, etc.), and data about educational opportunities that are to be presented at the trade show (e.g., white papers, presentations, demonstrations, seminars, etc.). This data is preferably collected by a trade show organizer prior to the show as exhibitors register for the trade show, sponsors agree to sponsor the show, advertisers reserve advertisement space for the show, and presenters submit papers or requests for live presentations. Exhibitor data preferably includes at least the exhibitor's name, address, website, telephone and facsimile numbers, area of business, names of employees working the show, and a description of the products and/or services to be showcased by the exhibitor. Sponsor and advertiser data preferably includes sponsor's/advertiser's name, address, website, telephone and facsimile numbers, area of business, and a description of the products and/or services to be advertised in the advertisement. Educational opportunity data preferably includes a description of papers (e.g., white papers, articles, etc.) to be made available as part of a trade show and a description of the live presentations (e.g., seminars, presentations of papers, demonstrations, identity of author/presenter, etc.) to be presented at the trade show.

The trade show item data 14 is preferably processed to assign items presented at the trade show into to categories appropriate for the particular trade show. For example, in a trade show that showcases new pharmaceutical products and treatments, each exhibitor and educational opportunity (e.g., each paper and each live presentation) may be categorized according to the disorder the product is meant to treat (e.g., sexual dysfunction, allergies, gastro-intestinal problems, etc.). Each exhibitor and educational opportunity may also be categorized according to the medical specialty likely to prescribe the product (e.g., family practice, internal medicine, dermatology, obstetrics/gynecology, etc.). Each exhibitor and educational opportunity may be assigned to a single category (e.g., allergy drug/treatment or family practice) or assigned to multiple categories (e.g., allergy drug/treatment and family practice). In another implementation, individual items that are to be presented within an exhibit are categorized. For example, a single exhibitor may wish to exhibit three different products and a white paper at a single exhibit at a trade show. In this case, in addition to categorizing the exhibitor or the exhibit, the individual products and white paper are categorized so that level of interest in each product as well as the white paper may be determined. Other trade show items may also be categorized such as advertisements that are to be placed on the show floor by a trade show sponsor or advertiser.

Since the exhibitor, exhibit, advertisement, and educational opportunity information is typically known prior to a trade show, it is preferable to categorize these items prior to the start of the show so that information indicating levels of interest trade show items and categories of trade show items may be determined during the show or shortly thereafter. However, other implementations may categorize (or re-categorize) trade show items during the show or after it has concluded.

A variety of attendee data may be collected in connection with the trade show. In a preferred embodiment, attendee's identification and demographic information (e.g., age, gender, personal income, household income, occupation, etc.) is collected during and/or before the show and stored in a data file or similar data structure (e.g., database) in a storage medium 20 (e.g., CD-ROM, hard drive, etc.). Attendee location is also preferably tracked and stored (e.g., in storage medium 20) during the show to determine which exhibits and live presentations are being visited by the attendees as well as duration of the visits. In addition, attendees are preferably provided with means for electronically requesting information associated with an exhibit or educational opportunity (e.g., request to bookmark an exhibitor, request for exhibitor to contact attendee, request for a white paper, etc.) and means for electronically providing information (e.g., attendee identification) to an exhibitor. Attendees requests for information associated with an exhibitor, sponsor, advertiser or educational opportunity as well as the provision of information to an exhibitor, sponsor or advertiser by an attendee, are also preferably tracked and stored during the show.

Attendee data and item data are processed to determine attendee levels of interest in the various exhibits, exhibitors, advertisements, educational opportunities or other items showcased at the trade show. Additionally, attendee data and categorized trade show item data are processed to determine attendee levels of interest in categories of items presented at the trade show.

Attendee level of interest may be presented in one or more of a myriad of ways. For example, a level of interest in an exhibit may be determined by the number of attendees in who visited the exhibit during the show or by the percentage of visitors to the exhibit who bookmarked the exhibit, requested contact from the exhibitor or provided identification information to the exhibitor. Similarly, attendee levels of interest in a category can be determined by the number of attendees who visited exhibits, took advantage of educational opportunities (e.g., requested a white paper, attended a presentation, etc.) or expressed interest in advertisements (e.g., requested information about a product shown in a advertisement) in a particular category. Additionally, attendee demographic information may also be used to provide a more detailed report as to “who” was interested in a trade show item or category of items. Moreover, data collected from multiple shows relating to the same industry may be consolidated and analyzed to provide an even more comprehensive view as to levels of interest by groups of people in that industry.

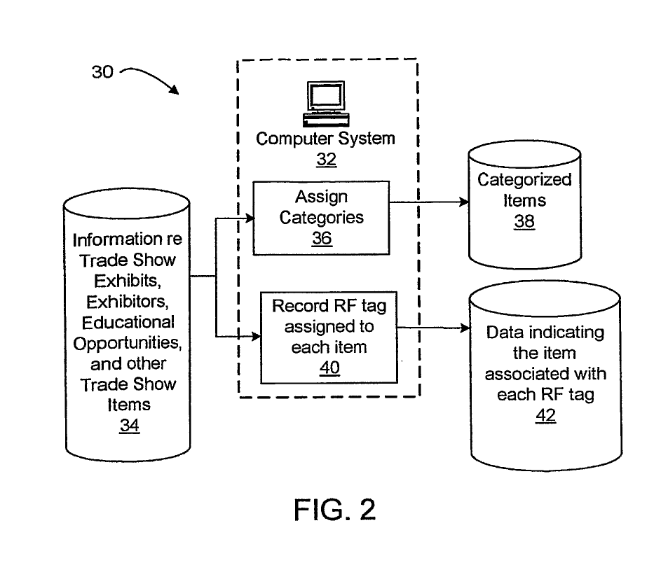

Referring to FIG. 2, in one implementation, a system 30 for collecting and processing trade show data includes a computer system 32 that receives information 34 about items (e.g., exhibits, exhibitors, products, services, demonstrations, seminars, papers, etc.) to be presented at an upcoming trade show and facilitates the assignment of items to one or more categories appropriate for the particular trade show. In a preferred embodiment, a user reviews the information about the trade show items and determines one or more sets of categories to be used for the particular trade show. Alternatively, a set of predetermined categories broadly relating to the particular industry showcased at the trade show may be used. After determining the categories, the user (through computer system 32) assigns each of the items into one or more of the determined categories. This assignment, along with a list and description of the categories, is stored 34 in a data table or similar structure (e.g., a database) on a storage device (e.g., hard drive, CD-ROM, etc.) in communication with the computer system 32.

Computer system 32 also facilitates the assignment 40 of a wireless device that uniquely identifies items (e.g., exhibits, products, services, white papers, seminars, demonstrations, advertisements, etc.) to be presented at the trade show. For example, in one implementation, a radio frequency (RF) transponder, known as an RF tag, having a unique identification code is assigned to items to be presented at the trade show. Typically, information associating each RF tag with a particular item is entered into a table, database, or other similar data structure, which is stored in a storage device 42 (e.g., hard drive, CD-ROM, etc.) in communication with the computer system 30. When the trade show floor is set up, the RF tag (or other wireless device) associated with each item is placed at the location of the corresponding item. For example, an RF tag associated with a banner advertising a sponsor's product or service could be attached to the banner. Similarly, an RF tag associated with an exhibit could be placed within the exhibit itself.

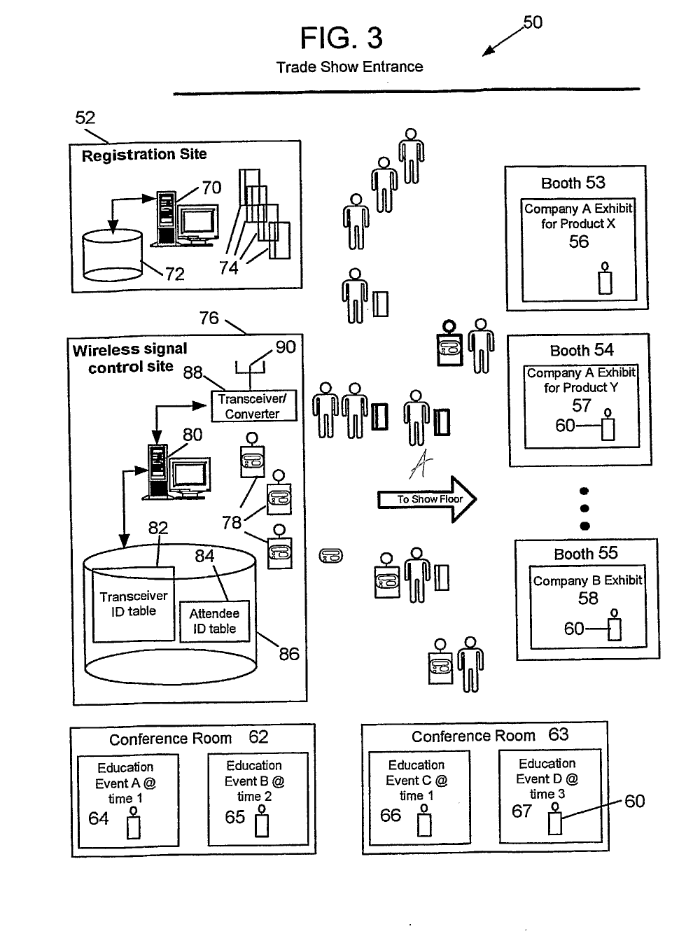

Referring to FIG. 3, in one embodiment, a trade show 50 includes a registration site 52 and a number of exhibitor booths 53-55 each housing an exhibit 56-58 presented by exhibitors (e.g., Company A and Company B) to attract the attention of trade show attendees. Note that in this example, Company A has two exhibits 56-57, one to showcase product “X” and a second to showcase product “Y”. An RF tag 60 that uniquely identifies the particular product is located within each booth housing. Assigning unique RF tags to individual items presented at a trade show enables collection of data indicating attendee interest at a fine level of granularity. Another system for collection of attendee data at a trade show is described in U.S. application Ser. No. 10/763,729, entitled “Information Exchanging” and filed by McSheffrey et al. on Jan. 23, 2004, the complete disclosure of which is fully incorporated herein by reference.

Referring again to FIG. 3, the trade show also includes a number of conference rooms 62-63 in which educational events 64-67 (e.g., seminars, demonstrations, etc.) are conducted at various times. In this example, educational events A and B are scheduled for conference room 62 at time 1 and time 2, respectively. Similarly, educational events C and D are scheduled for conference room 63 at times 1 and time 3, respectively. An RF tag 60 that uniquely identifies the educational event is present in the conference room during the education event.

As each attendee enters the trade show 50, the attendee stops by the registration site 52 to gain admission to the trade show floor by, for example, paying an entrance fee, if not previously paid. Along with gaining admission, while at the registration site 52, attendees provide information to be collected. In this example, the registration site 52 includes a computer system 70 for entering information associated with each admitted attendee such as contact information (e.g., attendee name, business mailing address, employment position, etc.). Typically, the information is entered into a table, database, or other similar data structure stored in a storage device 72 (e.g., hard drive, CD-ROM, etc.) in communication with the computer system 70. Also, each attendee may be requested or asked to complete a questionnaire that provides the organizers of the trade show with additional information such as the attendee's primary purpose for attending the trade show 50 and the information the attendee hopes to gain by attending.

The registration site 50 also offers a badge 74 to each attendee that bears, for example, a magnetic strip loaded by the computer system 70 with the contact information provided by the attendee. Other information, such as details associated with the attendee (e.g., attendee's salary, whether the attendee is a company decision-maker, etc.) or the attendee's company (e.g., company size, location, major products or services, etc,) may be collected and stored on the badge 74. Alternatively, if an attendee has pre-registered e.g., through the mail or through, a computer network (e.g., the Internet), a badge can be loaded with contact and other information before the attendee arrives at the trade show 50. While moving through the trade show 50 and engaging exhibitors, the attendee can temporarily hand his or her badge 74 to exhibitors to permit the exhibitor to collect information stored in the badge. Typically, each of the exhibitor booths 53-55 has a magnetic strip reader capable of reading information stored in each badge.

The trade show 50 also includes a wireless signal control site 76 that provides interested attendees with handheld wireless transceivers 78 capable of wirelessly sending and receiving information. Similar to the badges 74, each handheld wireless transceiver 78 exchanges information among trade show attendees and trade show exhibitors. Also, while the wireless transceivers 78 are referred to as handheld, the handheld wireless transceivers may be also be worn by the attendees (e.g., worn around the neck), clipped to the attendee's clothing, carried in a container (e.g., briefcase), or accompany the attendee in another similar manner. Before a handheld wireless transceiver is provided to an attendee, identification data (e.g., an identification number, etc.) unique to the particular handheld wireless transceiver is entered into a computer system 80 located at the wireless signal control site 76. Data is also entered into the computer 80, or provided from computer system 70 (e.g., through a local area network LAN, etc.), to identify the particular trade show attendee provided with the handheld wireless transceiver. Typically, this data is stored in respective tables 82, 84, or other similar data structures (e.g., database, data file, etc.), in a storage device 86 (e.g., hard drive, CD-ROM, etc.) in communication with the computer system 80.

The computer system 80 located at the wireless signal control site 76 is also in communication with a transceiver/converter 88 that receives and transmits wireless signals through an antenna 90 or other similar device (e.g., laser, photo-detector, acoustic transducer, etc.) dependent upon the wireless technology implemented at the trade show 10. For example, by receiving wireless signals from the handheld wireless transceivers 78 being carried by the trade show attendees, the transceiver/converter 88 can pass information associated with the trade show attendees, the trade show exhibitors, and the trade show to the computer system 80 for collection and processing.

In contrast to using badges, which must be handed to exhibitor personnel for swiping, by carrying or wearing a handheld wireless transceiver 78 while progressing though the exhibits 56-58 and attending various educational events 64-67 at the trade show 50 can collect information from an exhibitor/presenter of interest without directly engaging the exhibitor personnel stationed at the exhibitor booth or the individual(s) presenting the educational event. For example, an attendee with a handheld wireless transceiver may be interested in collecting information from the exhibit located in booth 53. By using the handheld wireless transceiver, the attendee can initiate transmission of a wireless signal to the wireless signal control site 76 to request information associated with the exhibitor without interfacing with the exhibitor personnel at the booth. This can have particular appeal and advantage, both to attendee and to exhibitor because, for example, if an attendee becomes fatigued at the trade show 50 and does not wish to spend energy and time to interface with exhibitor personnel in order to collect information from them, or, if the attendee has a timid personality a wirelessly initiated information request can be used to collect information without directly interfacing, or, if a particular booth is crowded with numerous people or the exhibitor personnel are currently away from a booth (e.g., on a lunch break), the attendee can use the handheld wireless transceiver to request information and not have to wait for the crowd to disperse or the exhibitor personnel to return.

The trade show attendee can also use the handheld wireless transceiver to grant particular exhibitors, sponsors, advertisers, or presenters permission to receive the attendee's contact information, again without directly interfacing with the exhibitor or other personnel. For example, after attending a selected educational event (e.g., educational event B), an attendee may be interested in communicating with the presenter or with a member of the presenter's organization (e.g., by telephone or electronic mail (email), etc.) at a later time after the trade show. Similarly, after seeing a sponsor's advertisement for a product, the attendee may be interested in communicating with the sponsor regarding the product. The attendee, to provide his or her contact information (e.g., business telephone number, email address, etc.) to the presenter or sponsor, initiates transmission of a wireless signal from the handheld wireless transceiver. The signal is received by the antenna 50 at wireless signal control site 36 where it is collected by the computer system 80. By controlling the flow of information to the exhibitors, presenters, sponsors and advertisers, the attendees determine which persons receive their contact information. The attendees can also use the handheld device to collect information from selected exhibitors, presenter, sponsors and advertisers. For example, after viewing a product exhibited at the show, the attendee can use his or her handheld device to request the exhibitors website or other contact information by bookmarking the exhibit or to request a copy of a white paper associated with the exhibit. During or at the conclusion of the show, the information requested by the attendee may be posted by the trade show organizer to a website accessible to the attendee. Thus, the wireless handheld devices place control of the information with the trade show attendees, and exhibitors, advertisers, sponsors and presenters are restricted from passively collecting contact information associated with attendees without grant of permission from the attendee for receiving such information.

The badges and wireless handheld transceivers can also provide means for tracking the location of attendees during the course of the show. For example, when an attendee swipes his or her badge at an exhibit, a signal identifying (i) the attendee, (ii) the exhibit at which the badge was swiped, and (iii) the time of the swipe may be relayed to the computer 80 at the wireless signal control site 76 where it is stored in a data table or similar data structure in a storage device 86 in communication with computer 80. Additionally, the wireless handheld transceivers 78 may be configured to automatically determine the exhibit or educational event that is in closest proximity to the handheld transceiver (e.g., by sensing the closest RF tag) and relaying a signal to the computer 80 at the wireless signal control site 76 that identifies the attendee, the nearest exhibit, and the time at which the nearest exhibit was determined. When the signal is received at the wireless signal control site 76, the information is stored in a data table or similar data structure in a storage device 86 in communication with computer 80. Data indicating attendee location during the trade show may be used e.g., to determine the popularity of the various exhibits and educational events showcased at the show.

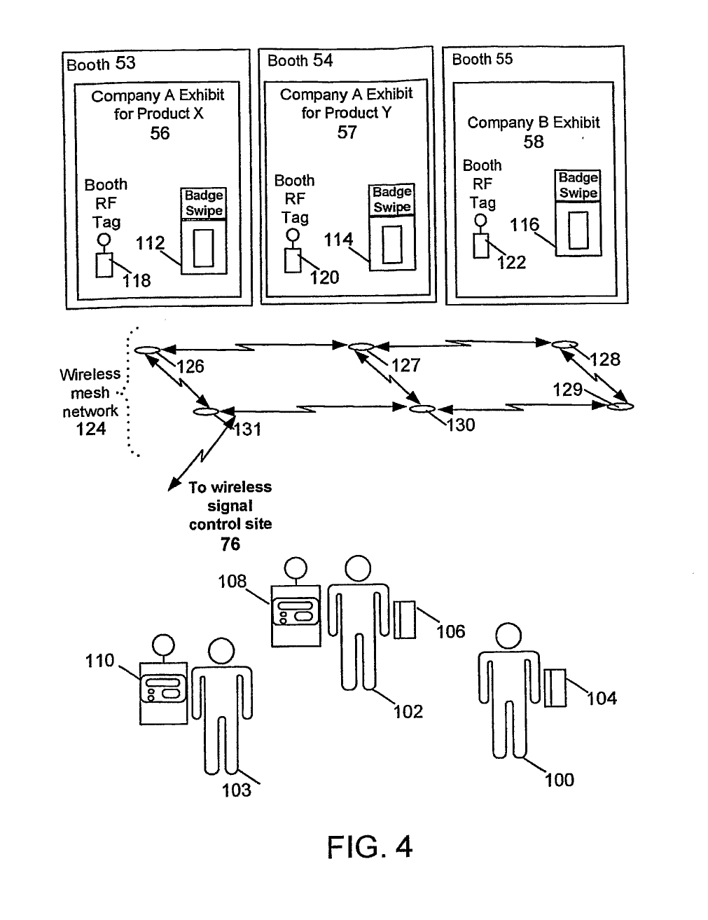

Referring to FIG. 4, in this particular example, three trade show attendees 100, 101, 102, 103 have chosen to carry and use different equipment for collecting and exchanging information with exhibitors at the trade show 50.

Attendee 100 is carrying or wearing one of the badges 74 with a magnetic strip that stores the attendee's contact information. To provide his or her contact information, for example, to the exhibitor personnel stationed at exhibitor booth 53, attendee 100 directly engages the exhibitor personnel and temporarily hands over his or her badge 104 for the exhibitor to collect their contact information. In this example, the exhibitor personnel uses a badge reader 112 located in the exhibitor booth 53 and reads the contact information stored in the magnetic strip of the badge. In this implementation, each of the badge readers are equipped with a wireless transmitter for transmitting badge swipe information to the wireless signal control site 76. When the badge is swiped, the badge reader transmits a signal to the wireless signal control site, which contains information sufficient to identify (i) the attendee (e.g., the attendees name or an identification code associated with the attendee) (ii) the exhibit where the badge was swiped, and (iii) the time of the swipe. When this information is received at the wireless signal control site, it is stored in a data table or similar data structure in a storage device in communication with computer 80 (shown in FIG. 3). In this way, the attendee's location on the trade show floor can be tracked during the course of the trade show by computer 80 at the wireless signal control site. In addition, the attendee's contact information is typically stored by the exhibitor in a storage device (not shown) in communication with the badge reader. After “swiping” the badge 104 through the badge reader 112, the exhibitor personnel returns the badge to the attendee 100. The attendee can then present the badge to be swiped in other badge readers 114, 116 located in other exhibitor booths 54, 55, thus providing the attendee's contact information selectively to other exhibitors.

Attendees 102 and 103 are carrying or wearing a handheld wireless transceivers 108, 110. By using the handheld wireless transceivers 108, 110 the attendees 102, 103 can collect information from selected exhibitors, and grant permission for access to their contact information, without directly engaging the exhibitor personnel at the booths 53, 54, and 55. Also, in this example, attendee 102 has also chosen to carry a badge 106 so that if he or she does directly engage an exhibitor, the attendee can hand over the badge so that the exhibitor can collect the attendee's contact information.

By providing the trade show attendees with both badges and wireless tags, the trade show organizer can track and produce statistics conveying the number of attendees passively interacting with exhibit booths by using handheld wireless transceivers, as well as the number of attendees directly engaging with exhibitor personnel by handing over their badges. This information could be used e.g., to measure effectiveness of the exhibitor personnel.

As each of the attendees 102, 103 using handheld wireless transceivers 108, 110 comes in close proximity with one of the exhibitor booths 53-55, a wireless link is established with a respective RF tags located in the booth. For example, as attendee 103 comes in close proximity to booth 53, the handheld wireless transceiver 110 carried by the attendee establishes a wireless link with RF tag 118. Similarly, as attendee 102 comes in close proximity with booth 54 or booth 55, respective RF tags 120 and 122 establish wireless links with the attendee's handheld wireless transceiver 108. To establish a wireless link, each handheld wireless transceiver includes a radio frequency (RF) source, such as an RF reader, that propagates RF energy to the RF tag. The RF tag, which is tuned to resonate at the RF energy frequency, receives the energy and uses the received energy to transmit a wireless signal to the handheld wireless transceiver and establish the wireless link.

By establishing the wireless link, data representing information associated with the exhibitor (e.g., identification information) is passed from the RF tag to the handheld wireless transceiver. The attendee can then decide whether to request information from the exhibitor, whether to grant the exhibitor permission to receive the attendee's contact information, and/or to indicate other similar decisions. For example, after receiving exhibitor information from the RF tag 118 in booth 53, the attendee 103 may decide to request information from the exhibitor at booth 53. Upon making the decision, the attendee 103 can use the handheld wireless transceiver 110 to send a wireless signal back to the wireless signal control site 76 requesting that the exhibitor information be provided to the attendee. By using a wireless signal to initiate the request, the attendee does not have to take notes, remember which exhibitors were interesting, or pick up material at the exhibitor's booth.

In one implementation, the handheld transceiver 78 is also programmed to automatically transmit a signal to the wireless signal control site 76 if the handheld transreceiver detects the presence of an RF tag for a predetermined amount of time (e.g., 5 minutes) indicating, for example, that the attendee has visited the exhibit or educational event. The signal transmitted to the wireless signal control site 76 preferably includes information sufficient to identify (i) the attendee (e.g., the identification code of the handheld device issued to the attendee), (ii) the exhibit or educational event visited (e.g., the RF code stored in the RF tag associated with the exhibit/educational event) and (iii) the duration of the visit. This information is received at the wireless signal control site 76 where it is stored in, for example, a data table or similar data structure (e.g., database, data file, etc.) in a storage device 86 (e.g., hard drive, CD-ROM, etc.) in communication with the computer system 40. To protect the privacy of the attendee, the information indicating the exhibits and educational events visited by an attendee is preferably not directly associated with the attendee's name in the data table, but rather is associated with some other identifier such as the identification code of the wireless device issued to the attendee or another identification code associated with the attendee.

In another implementation, the handheld device 78 is configured to automatically transmit a signal to the wireless signal control site 76 whenever the handheld device detects a new RF tag. For example, each time a wireless handheld device 78 detects an RF tag, it transmits a signal that preferably includes information sufficient to identify (i) the attendee (e.g., the identification code of the handheld device issued to the attendee), (ii) the exhibit or educational event visited (e.g., the RF code stored in the RF tag associated with the exhibit/educational event) and (iii) the duration that the RF tag was detected. This information is received at the wireless signal control site 76 where it is stored in, for example, a data table or similar data structure (e.g., database, data file, etc.) in a storage device 86 (e.g., hard drive, CD-ROM, etc.) that is in communication with the computer system 40.

In another implementation, a Global Positioning System (GPS) receiver is included within the wireless handheld transceiver 78. The handheld transceiver is programmed to automatically obtain position information via the GPS receiver at predetermined intervals and relay a signal to the wireless signal control site 76 that identifies (i) the handheld device (ii) GPS coordinates of the current position and (iii) the time at which the GPS coordinates were obtained. This information is received at the wireless signal control site where it is stored in a data table or similar structure in a storage device 86 is in communication with the computer system 80. Sometime after receiving the GPS signal, the computer 80 at the wireless signal control site compares the received GPS coordinates to a map of the trade show floor to determine what booth or presentation, if any, the attendee is currently visiting. In another embodiment, a wireless handheld device is loaded with item information that is mapped to particular ranges of GPS coordinates. For example, the trade show floor may be divided into a grid of 20 foot by 20 foot sections and information about items in each of the sections are mapped to the GPS coordinates associated with the section. When the GPS receiver receives coordinates that are within a mapped section, the handheld device displays item information for each of the items in that section, which the attendee may bookmark, request information from, etc. Note that in this embodiment, the need for RF tags and an RF reader are eliminated.

Referring again to FIG. 4, the wireless signal initiated from the handheld wireless transceivers 108, 110 or from one of the bar code readers 112-116 is received by one or more nearby wireless repeaters 126-131 that together produce a wireless mesh network 124. The wireless signal received by one or more of the wireless repeaters 126-131 is then passed to other wireless repeaters in the wireless mesh network for relay to the wireless signal control site 76 for reception and processing. Distribution of the wireless repeaters 126-131 throughout the trade show floor permits the handheld wireless transceivers 108, 110 to have relating lower power levels, e.g. as compared to the power level required to propagate signals directly from the handheld wireless transceiver to the wireless signal control site 76. In this embodiment, each of the wireless repeaters 126-131 receives and transmits electromagnetic signals (e.g., radio frequency (RF) signals). However, in other embodiments, other wireless techniques or combinations of wireless techniques may be implemented to pass signals among the repeaters and the wireless signal control site 76. For example, infrared technology, laser technology, acoustic technology, or other types of wireless technology may be implemented individually or in combination into the wireless mesh network 90. In yet other embodiments, attendee data is saved locally on a storage device (e.g., a hard drive, CD-ROM) in communication with the handheld device and is uploaded to computer 80 after the attendee returns the handheld device.

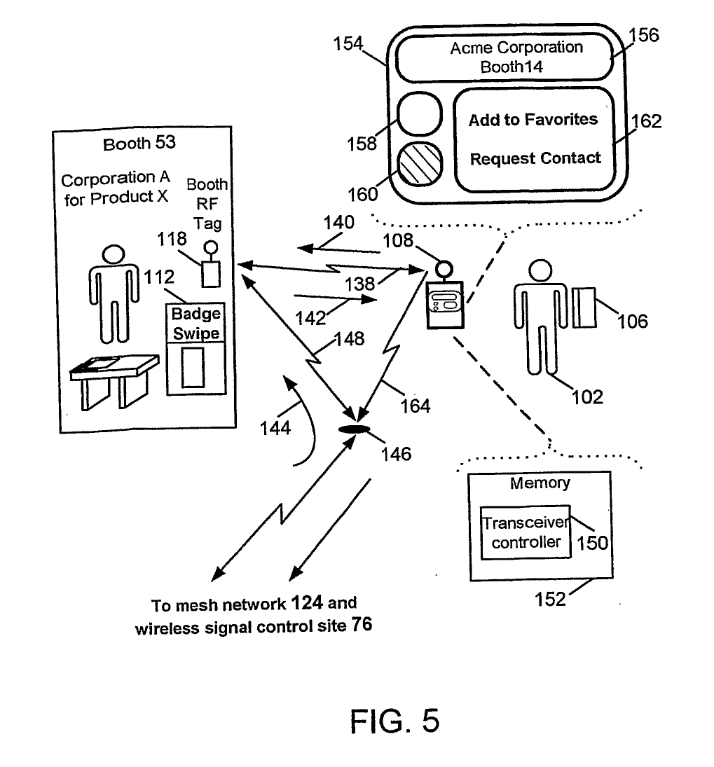

Referring to FIG. 5, in this embodiment, as attendee 102 comes within close proximity of exhibit booth 53, a wireless link 138 is established between the RF tag 118 and the handheld wireless transceiver 108 being carried by the attendee. In this example, the wireless link 138 is established by the handheld wireless transceiver 108 transmitting an RF signal 140 at a particular frequency (e.g., 13.56 Mega Hertz), such that when the RF signal is received by the RF tag 118, circuitry included in the tag tuned to the RF signal frequency resonates, and an RF response signal 142 is produced and transmitted to the handheld wireless transceiver 108, which includes circuitry for receiving the response signal.

The RF signal 142 transmitted to the handheld wireless transceiver 108 includes data representing information associated with the exhibitor and the booth 53 where the RF tag 118 is positioned. For example, data that identifies the exhibitor (e.g., exhibitor name, a unique number assigned to the exhibitor, etc.) and the exhibitor's booth (e.g., booth number, booth location on the trade show floor, etc.) is included in the RF signal 142. As shown in FIG. 2, in some embodiments, this identification data is stored in the RF tag 118 prior to it being positioned in the exhibitor booth 53. However, in other embodiments, the data is stored in the RF tag 118 after it is positioned in the booth. For example, data representing the exhibitor's identity and the number assigned to the booth is entered into the computer system 80 located at the wireless signal control site 76. The data is then transmitted in a wireless signal from the wireless signal control site 76, through the wireless mesh network 100, and delivered to the RF tag 118. In this particular example, a wireless signal 144 to be transmitted through the wireless mesh network 124 is received by a repeater 146 included in the wireless mesh network 124. The repeater relays the wireless signal 144 over a wireless link 148 established between the RF tag 118 and the repeater 146. Upon receiving the signal 144, the RF tag 118 decodes the identification data included in the signal and stores the data in a memory device (e.g., EPROM chip, EEPROM chip, etc.) included in the tag.

Upon receiving the RF response signal 142, the handheld wireless transceiver 108 decodes the signal to retrieve the data representing the identity of the exhibitor and the booth being used by the exhibitor. In this embodiment, transmission of the wireless signal 140, reception of the wireless signal 142, decoding of the data, and other processes are provided by a transceiver controller 150, which is executed in the handheld wireless transceiver 108. In this embodiment, the transceiver controller 150 is stored in a memory 152 (e.g., random access memory (RAM), read-only memory (ROM), static RAM (SRAM), dynamic RAM (DRAM), etc.) included in the handheld wireless transceiver. In other embodiments the transceiver controller 150 is loaded into the memory 150 from a storage device (e.g., a hard drive, CD-ROM, etc.) in communication with the handheld wireless transceiver 108.

After decoding the identification information from the signal 142, the transceiver controller 150 presents the information in a graphical user interface (GUI) 154 so that the attendee 102 can determine which exhibitor booth is currently being linked with wireless link 138. In this example, a field 156 in the GUI 154 presents the identity of the particular exhibitor (e.g., Acme Corporation) and a number assigned to the particular booth where the exhibitor is located (e.g., Booth 53). Textual information is used to present the identity of the exhibitor and the exhibitor's booth. However, in other embodiments, the GUI 154 presents other types of content with or without the textual information to identify the exhibitor. For example, trademarks, logos, or other graphical identifiers may be presented in the GUI 154. Also, video content (e.g., advertisements, product demonstrations, etc.) may be presented with or without audio content associated with the exhibitor and decoded by the transceiver controller 150 from the wireless signal 142. In another embodiment, RF tags associated with items that are in close proximity to one another (e.g., RF tags associated with several items in one booth) are bundled together. When a handheld device comes within close proximity of the bundled tags, it reads multiple tags and displays information about each of the items on a GUI on the display.

Referring again to FIG. 5, the GUI 154 also includes two selectors 158, 160 used by the attendee to enter selections based on the identification information presented in field 162. In this embodiment, each selector 158, 160 respectively corresponds to text presented in another field 162 included in the GUI 154, although as mentioned above, other types of content (e.g., trademarks, video, audio, etc.) may be presented to the attendee to assist in making one or more selections. In this embodiment, each selector 158, 160 is touch-sensitive and can detect when it is pressed by the attendee, however, in other embodiments, other sensing techniques, e.g. such as light obstruction detecting, body heat detecting, etc., may implemented.

Based on the attendee's interest, either or both selector 158, 160 may be selected. Here, selector 158 is selected by the attendee 54 to indicate that he or she is interested in the exhibitor presented in field 156 (e.g., Acme Corporation) in a list of “favorite” exhibitors specific to the attendee. For example, the attendee 102 may be interested in all exhibitors at the trade show 50 that are producing a particular style of luxury car. So, for each instance in which the attendee establishes a wireless link with a booth being used by a luxury car manufacturer, the attendee can select to add that manufacturer to his or her running list of “favorites”. To add the exhibitor to the list of “favorites”, the attendee 102 presses selector 158, and transmission of a wireless signal 164 is initiated from the handheld wireless transceiver 108 to eventually be received at the wireless signal control site 76 where the list is stored. The wireless signal 164 includes data identifying the user selection to add the exhibitor to his or her list of “favorites”. The wireless signal 164 also includes data that identifies the particular handheld wireless transceiver 108 so the specific attendee initiating the signal can be determined at the wireless signal control site 76. In this embodiment, the transmitted wireless signal 164 is received by the wireless repeater 146 in close proximity to the handheld wireless transceiver 108. However, in some embodiments, the RF tag 118 includes electronic circuitry so that the wireless signal 164 is received by the RF tag and then transmitted to the wireless repeater 146 for transmission through the wireless mesh network 124 to the wireless signal control site 76.

Along with selecting to add the exhibitor to a list of “favorite” exhibitors, in this embodiment, the attendee can also select to request that the exhibitor contact the attendee 102 after the trade show. By pressing the selector 160, transmission of a wireless signal similar to wireless signal 164 is initiated from the handheld wireless transceiver 108, through the wireless mesh network 124, and to the wireless signal control site 76 where it is stored. By pressing selector 160, the attendee grants permission for the exhibitor to receive the attendee's contact information from the trade show organizer. Thus, unless the attendee presses the selector 160, or hands over a badge for the exhibitor to swipe through the badge reader 112, the attendee's contact information is held in confidence by the trade show organizer and not provided to the exhibitors.

In these embodiments, the wireless signal 118 includes data representing selections (e.g., “Add to Favorites”, “Request Contact”) made by the attendee, along with data representing the handheld wireless transceiver 66 initiating transmission of the signal. However, in other embodiments, other information is included in the wireless signal 118. For example, the time at which the attendee make the selection may be determined from an internal clock in the wireless transceiver 108. Additionally, the location of the attendee on the trade show floor may be determined from a global position system (GPS) receiver included in the handheld wireless transceiver 108. In another embodiment, the location of the attendee may be determined by including information sufficient to identify the RF tag 118 associated with the booth 53. In this embodiment, the computer 80 at the wireless signal control site 76 determines the location of the attendee by locating the position of the booth 53 associated with the particular RF tag 118 using, for example, a data table that maps booths and educational events with their respective RF tags. Alternatively, the position of the attendee may be inserted into the wireless signal 146 by the first wireless repeater in the wireless mesh 124 to receive the signal after being transmitted from the handheld wireless transceiver 108. In this example, since wireless repeater 146, which is located near to booth 53, is the first member of the wireless mesh network 124 to receive the wireless signal 164, it may insert data identifying the wireless repeater into the wireless signal so that the wireless signal control site 76 can approximately determine where the attendee is located.

In another embodiment, RF tags associated with items in a particular area (e.g., within a particular booth, within a 20 foot by 20 foot grid, etc.) are grouped together such that when a handheld device comes within the area, information about all of the trade show items having an RF tag in that area are displayed on the screen of the handheld device. The attendee may then use a graphical user interface to bookmark or request information about one or more of the items that interests the attendee.

In some embodiments, each wireless signal is encoded and/or encrypted to provide secure data transmission and to reduce interference among the wireless transmissions. In this embodiment, the handheld wireless transceiver 108 used by the attendee includes circuitry for reading the information stored in the RF tags along with circuitry for establishing wireless links; however, in other embodiments, a cellular telephone, a personal digital assistant (PDA) with wireless transmission and reception circuitry, or other similar wireless signaling device can be used by the attendee to execute the operations of the transceiver controller.

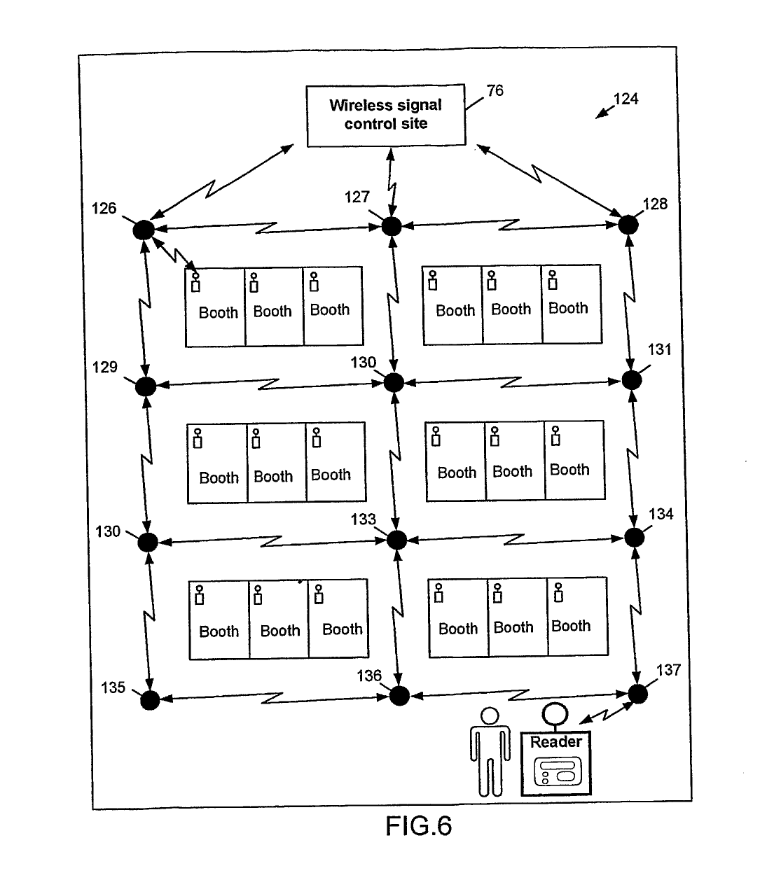

Referring to FIG. 6, in this embodiment, the wireless mesh network 124 includes, for example, twelve wireless repeaters 126-137 distributed in a grid pattern throughout the trade show floor. Typically, the wireless mesh network 124 includes more wireless repeaters. For example, in some embodiments, one or more wireless repeaters are located proximate to each exhibitor booth at the trade show. In the embodiment illustrated in FIG. 4, each wireless repeater 170-181 is floor-mounted; however, in other embodiments, some or all of the wireless repeaters may be ceiling-mounted and/or wall-mounted. Besides using a grid system, the wireless repeaters may be distributed in other geographical shapes (e.g., a spiral distribution, concentric circle distribution etc.) to provide different resolving granularity for localizing the handheld wireless transceiver initiating a wireless signal transmission to the wireless signal control site 76.

In order to prevent loss or theft of the handheld devices, the hand held devices are preferably equipped with a speaker that generates an audible alarm (e.g., a beep) when they are removed from the wireless repeater mesh network. Thus, when an attendee leaves the wireless repeater mesh network (e.g., walks off the show floor) he or she is reminded to return the handheld device.

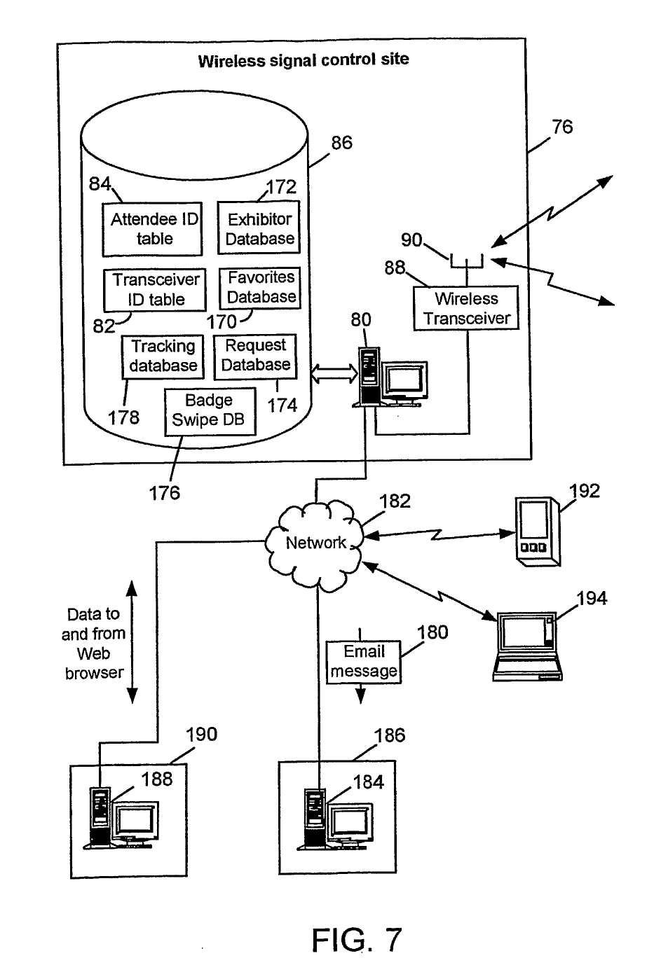

Referring to FIG. 7, after passing through the wireless mesh network 124, the wireless signals transmitted by the handheld devices are received by the wireless signal control site 76. In this embodiment, the wireless signals are received by the antenna 90 located at the reception site 76 and passed to the transceiver/converter 88. The transceiver/converter 88 decodes the wireless signals and decrypts the signals to remove any previously applied encryption scheme. The transceiver/converter 88 also converts and/or conditions the signals into digital signals that are sent to the computer system 80 for processing and for storing the information included in the wireless signals.

For example, some received wireless signals include data identifying the particular handheld wireless transceiver that initiated the wireless signal along with data identifying a particular exhibitor to be added to a list of favorites exhibitor specific to the attendee using the handheld wireless transceiver. Upon receiving the data, the computer system 80 respectively stores data identifying the exhibitor in a “Favorites” database 170 in the storage device 86. Also, by using the data identifying the particular handheld wireless transceiver that sent the wireless signal, along with the data in tables 82, 84, the particular attendee associated with the list of “Favorites” is identified along with which particular list that should be accessed to add the data identifying the exhibitor. By identifying the exhibitor in a list of “Favorites”, information (e.g., advertisements, product specifications, white papers, web sites, etc.) associated with each “favorite” exhibitor can be retrieved from an exhibitor database 172 and sent, along with the list itself, to the particular attendee who selected to receive information about the exhibitor.

Along with data identifying the handheld wireless device that sent the signal, wireless signals may also include, data representing an attendee selection to request contact from a particular exhibitor. In this embodiment, the request is stored in a request database 174 along with data representing the attendee making the request, which is typically provided by the attendee ID table 84. Since both the attendee requesting contact and the exhibitor of interest, are identified by the request, the particular exhibitor is granted permission to be given the attendee's contact information.

Wireless signals may include data indicating that an attendee has had his or her badge swiped at a particular exhibit. In this embodiment, data indicating a badge swipe, including data sufficient to identify the attendee and the exhibit at which the badge was swiped, is stored in badge swipe database 176 in storage device 86.

Wireless signals may also include data automatically transmitted from the wireless transceiver to indicate which exhibits and/or educational events were visited by the attendee. This data preferably includes information sufficient to identify the attendee, the exhibits and educational events visited by the attendee, and the duration of each visit. This data is stored in tracking database 178 in storage device 86.

In other embodiments, other data associated with the received wireless signals is stored in the storage device 86. For example, an additional tracking database may store data from each received wireless signal so that the location of each attendee that initiated the signal with a handheld wireless transceiver can be tracked and time-stamped. For example, an attendee standing near one booth may use his or her handheld wireless transceiver to send a wireless signal at one time that indicates the location of the attendee and the time the transmission was initiated. Then, at a later time, the attendee, from a location near another exhibitor booth, may initiate a wireless transmission that is received by a different wireless repeater in the wireless mesh network 124. This second wireless signal propagates though the wireless mesh network 124 to be received at the wireless signal control site 76 where it provides data that is stored in the additional tracking database to retain the location of the attendee at the later time.

After the trade show has ended and attendee data has been stored, the computer system 80 can retrieve portions of the stored information, along with other information, for sending to the attendees. For example, the computer system 80 can execute processes to send each respective attendee their list of favorite exhibitors collected during their time at the trade show. Additionally, along with the list of favorites, the computer system 80 can be used to collect and respectively send to the attendees website addresses (e.g., Uniform Resource Locator (URL) addresses, etc.), advertisements, white papers, journal articles, and other informational content associated with each favorite list entry. In one embodiment, once collected, the list of favorites and other information is attached to an email message 180 that is sent from the computer system 80, through a network 182 (e.g., the Internet, a local area network (LAN), a wide area network (WAN), etc.) and delivered to an email address provided by the attendee. For example, one attendee may provide an email address when he or she registers so that they are able to receive the email message 180 at a computer system 184 located at their business 186. Additionally, the attendee may provide other email addresses for viewing the list of favorites on a computer system at the attendee's home.

In this embodiment, the collected information content associated with each favorite list entry is placed in a webpage developed with the computer system 80 so that the attendee can access the website to view and retrieve the collected information. For example, after leaving the trade show 50, an attendee can access a website associated with the trade show organizers from a computer system 188 located at his or her home or place of business 190. Once the website is accessed, the attendee can navigate through the website to the particular webpage or pages containing the collected information associated with each entry the attendee selected for inclusion in his or her list of favorite exhibitors. Furthermore, in some arrangements, the attendee enters a password or uses another security technique to gain access to the webpage or webpages with the collected information. Additionally, the content of the webpage or pages may be encrypted prior to being sent from the computer system 80 through the network 182 for delivery and decrypting by the computer system 188 at the attendee's home or place of business 190. By collecting and presenting such information in an email message or on one or more webpages, trade show attendees do not need to collect literature, papers, and other material from each exhibitor that the attendee may find interesting. Also, by electronically providing the information to the attendees, the exhibitors can bring less material to the trade show for distribution to attendees. By reducing the time and burden to collect information from exhibitors, an attendee can use the conserved time for longer and more in-depth discussions with the exhibitors and visit more exhibitor booths. In this particular embodiment, the computer systems 184 and 188 receive emails or interact with websites that include the attendees' list of favorites and other information. However, in other embodiments, a PDA 192, a laptop 194, or similar digital device such as a cellular telephone is used to wirelessly, or by hardwire, connect to the network 182 and receive the email messages or access the websites.

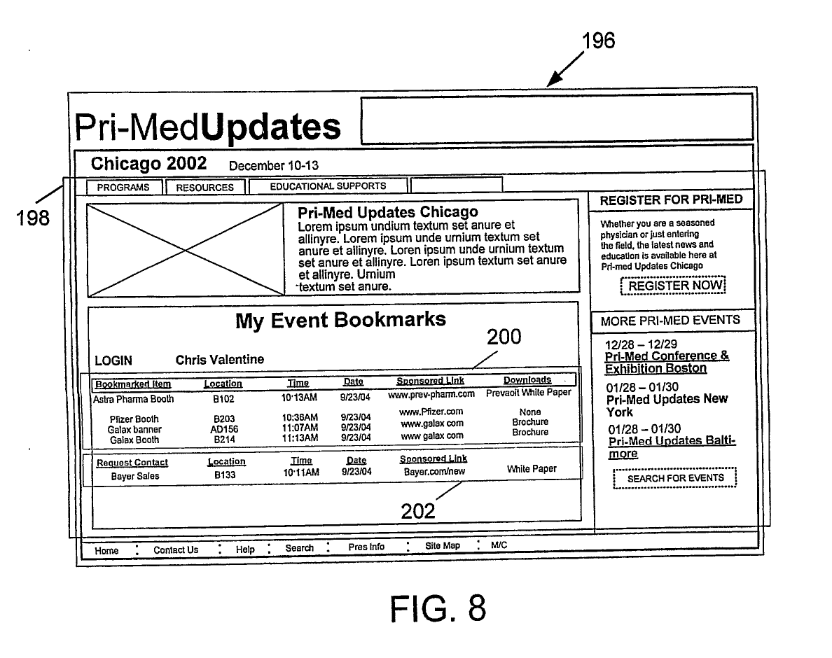

Referring to FIG. 8, an exemplary webpage 196 is shown, including a graphical user interface (GUI) 198 presenting the list 200 of favorite exhibitors collected by a particular trade show attendee (e.g., Chris Valentine). The GUI 198 also includes a list 202 of exhibitors to which the attendee has granted permission to receive his contact information from the trade show organizers, thus allowing the exhibitor (e.g., Bayer Sales) to contact the attendee at a later time for additional discussions and information exchanging. In this embodiment, each entry in the list 200 of favorites and the list 202 of contact requests includes the particular location, time, and date in which the attendee either selected to add the exhibitor to the list of favorites or selected to request contact from the exhibitor. By presenting this location and temporal information in the GUI 198, the attendee can better recall the exhibitor he selected, based on his location and the time of day the selection was made. In this embodiment, each list 200, 202 also includes a URL website or other computer network contact information (e.g., email address) associated with each list entry so the attendee can relatively quickly link and view a website associated with any list entry. Additionally, the lists 200, 202 include information respectively associated with each list entry that can be downloaded. For example, some of the list entries have white papers or brochures that can be downloaded while other list entries may not provide downloadable material for inclusion in the GUI 198.

By issuing handheld devices and badges, the system 50 collects different types of information from attendee's during the trade show including data indicating a badge swipe, a bookmark, a request for information, a request to be contacted, and a visit to an exhibit or live presentation. This collected information provides an indication of attendee interest in the various trade show items and/or categories of trade show items. For purposes of this disclosure, an “item of interest” means an trade show item in which an attendee has shown some interest by, for example, bookmarking the item, requesting information about the items, requesting contact from a person associated with the item (e.g., via a handheld device), providing contact information to a person or company associated with the item (e.g., via a badge swipe), or spending a predetermined amount of time (e.g., 5 minutes) in an area associated with the item (e.g., an exhibit booth).

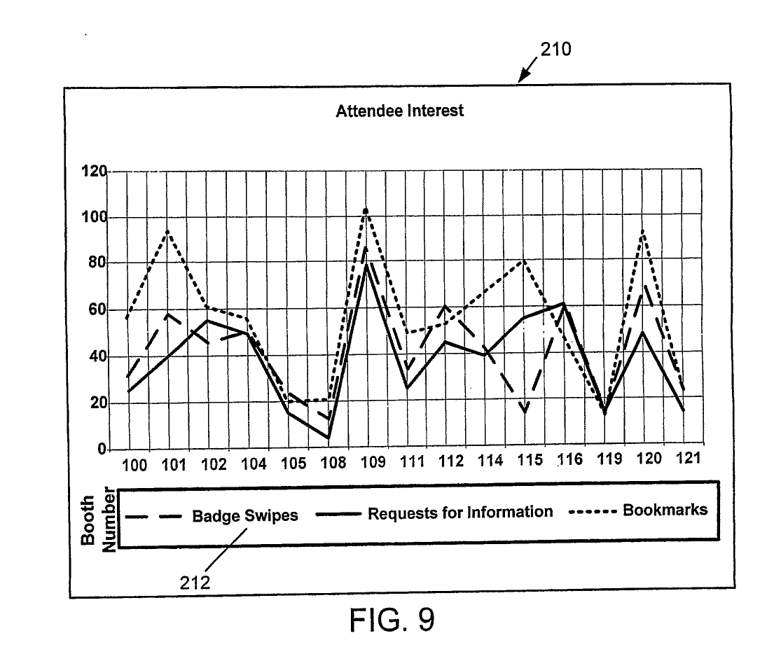

Referring to again to FIG. 7, in addition to the sending information to the attendees, computer system 80 also processes the data collected at the trade show (e.g., the data contained in data tables 82, 84 and databases 170-178) to produce statistics based on the items of interest of the trade show attendees that convey levels of interest in trade show items, such as the number of attendees passively interacting with each exhibit booth by using handheld wireless transceivers, the number of attendees directly engaging exhibitor personnel and handing over their badges, the percentage of attendees requesting information from a trade show sponsor or advertiser, and the number of people visiting an exhibit booth or educational event. These statistics allow trade show organizers, exhibitors and others (e.g., trade show sponsors, advertisers, market analysts, etc.) to discern the levels of interest in the various exhibits, advertisements, educational events and other items presented at the trade show. For example, as shown in FIG. 9, a report 210 includes a chart 212 showing the number of badge swipes, requests for information, and bookmarks recorded for booths 100-121 during a trade show. Report 210 may be generated in hardcopy or electronic form and may be distributed to interested parties (e.g., trade show organizers, exhibitors, sponsors, advertisers, market analysts, etc.) via an appropriate channel (e.g., regular mail, email, network (e.g., Internet) connection, etc.).

As previously mentioned, the various trade show items may be placed into one or more categories before the show (e.g., via computer 32 shown in FIG. 2) or after the show has begun (e.g., via computer 70). Computer 80 may process the data collected during the show to produce statistics that convey levels of interest in the categories, such as the number of attendees passively interacting with exhibit booths in a category, the number of attendees directly engaging exhibitor personnel in a category, the number of times attendees requested information from a sponsor or advertiser, the percentage of attendees expressing some interest (e.g., by visiting an exhibit or presentation, by book marking an item, by submitting contact information, by performing a badge swipe, etc.) in all items in a category. These statistics allow trade show organizer, exhibitors and others (e.g., trade show sponsors, advertisers, market analysts, etc.) to discern levels of consumer interest in various market segments represented at the trade show.

In addition to analyzing the captured trade show data to determine how many attendees visited, bookmarked, requested to be contacted, performed a badge swipe, etc. at various booths/educational events, computer 80 may use attendee data collected in connection with the show (e.g., at the registration site) or other attendee data (e.g., commercially-available data about attendees) to provide a more detailed report as to “who” was interested in particular exhibits, exhibitors, educational opportunities or categories. For example, attendees visiting an exhibit, exhibitor, educational event and/or category may be segmented by age, gender, profession, years of experience, income level, or by any other category for which data exists, to discriminate among attendees and provide information showing a level of interest in an exhibit, exhibitor, educational event or category among the selected segment.

Computer 80 is capable of generating a host of reports relating to levels of attendee interest in exhibits, exhibitors, educational events, and/or categories. For example, in a medical trade show context, a report may show the number of surgeons from large hospitals interested in the latest cardiac surgical equipment. Another report may reveal the number of female physicians between the ages of 25 and 40 that attended the Botox® seminar. Still another report may reveal the number of private investors who spent over 30 minutes at the Lipitor® exhibit. Additionally data from several trade shows in a particular industry (e.g., health care, computers, etc.) may be combined to show trends in attendee interest in trade show items and/or categories.

Reports showing various levels of interest at a trade show may be highly valued by trade show organizers, exhibitors, attendees and others, such as trade show sponsors, advertisers, investors, and market analysts. For example, a trade show organizer may have difficulty quantifying an anticipated return on investment (ROI) for a prospective exhibitor, sponsor or advertiser. However, a custom report generated using computer 80 to show levels of interest of attendees at a similar trade show for the particular market segment occupied by the prospective exhibitor, sponsor or advertise may be used by the trade show sponsor to give the prospective exhibitor, sponsor, or advertiser of an indication of the level of interest in the relevant market segment at the upcoming trade show.

Additionally, data collected at one trade show may be compared to data collected at other trade shows to provide trade show organizers and others with an indication of the level of success of a particular trade show.

Data need not be processed and after the completion of the trade show. Rather, since attendee data is collected in real time, reports showing level of interest in exhibits, educational events and/or categories may be generated during the course of the trade show. Reports showing the number of attendees visiting an exhibit over the course of the day, or during certain hours of a day, may be particularly valuable to trade show exhibitors in staffing their exhibit for the next day of the show.

Reports showing demographics of visitors to particular exhibits may also be of particular interest to exhibitors seeking to adapt their exhibits to appeal to their target market segment or to refine their target audience or expand their customer base. In addition, outside investors (e.g., market analysts) may value such reports as a barometer for future success (or lack of success) of a particular product, exhibitor, or category represented at a trade show.

The foregoing description should be considered as illustrative only of the principles of the invention. Further, since numerous modifications and changes will readily occur to those skilled in the art, it is not desired to limit the invention to the exact process and operation shown and described, and accordingly, all suitable modifications and equivalents may be resorted to, falling within the scope of the invention. Thus, it will be apparent to those skilled in the art that many changes and substitutions can be made to the preferred embodiments described without departing from the spirit and scope of the present invention as defined by the following claims.

What is claimed is:

1. A computer-implemented method for processing data, comprising:
receiving exhibit data indicating the identity of one or more selected trade show exhibits among a plurality of a trade show exhibits;
receiving information indicating trade show exhibits visited by one or more selected trade show attendees among a plurality of trade show attendees during a trade show;
correlating the exhibit data according to a predetermined set of exhibit categories; and
determining a level of interest of one or more selected trade show attendees among the plurality of trade show attendees in selected one or more elements of the set of categories based on the received trade show attendee data.

2. The method of claim 1, further comprising:
receiving attendee identity data indicating the identity of one or more selected trade show attendees among the plurality of a trade show attendees; and
correlating the attendee identity data according to one or more selected attendee categories among a predetermined set of attendee categories.

3. The method of claim 2, wherein determining a level of interest comprises:
determining a level of interest in one or more selected exhibit categories among the set of exhibit categories based on the correlated attendee data.

4. The method of claim 1, further comprising:
receiving seminar information indicating seminars attended by one or more selected trade show attendees among the plurality of trade show attendees during a trade show; and
correlating the seminar information according to one or more selected seminar categories among the predetermined set of seminar categories.

5. The method of claim 4, further comprising:
determining a level of interest in one or more selected seminar categories among the set of seminar categories based on the received seminar information indicating seminars attended by one or more selected trade show attendees among the plurality of trade show attendees.

6. A computer-implemented method for processing trade show data comprising:
receiving item data indicating the identity of one or more selected trade show items among a plurality of a trade show items;
receiving attendee data indicating items of interest by one or more selected trade show attendees among a plurality of trade show attendees;
correlating the item data according to a predetermined set of exhibit categories; and
determining a level of interest of one or more selected trade show attendees among the plurality of trade show attendees in selected one or more elements of the set of categories based on the received trade show attendee data.

7. A method of claim 6 wherein the item data and the attendee data comprise data from multiple trade shows.

8. The method of claim 7 further comprising:
receiving attendee identity data indicating the identity of one or more selected trade show attendees among the plurality of a trade show attendees; and
correlating the attendee identity data according to one or more selected attendee categories among a predetermined set of attendee categories.

9. The method of claim 8, wherein determining a level of interest comprises:
determining a level of interest in one or more selected exhibit categories among the set of exhibit categories based on the correlated attendee data.

10. A computer program product for processing trade show data, the computer program product containing instructions stored on a computer-readable that when executed by a processor cause the processor to:
receive exhibit data indicating the identity of one or more selected trade show exhibits among a plurality of a trade show exhibits;
receive information indicating trade show exhibits visited by one or more selected trade show attendees among a plurality of trade show attendees during a trade show;
correlate the exhibit data according to a predetermined set of exhibit categories; and
determine a level of interest of one or more selected trade show attendees among the plurality of trade show attendees in selected one or more elements of the set of categories based on the received trade show attendee data.

11. The computer product of claim 10 further comprising instruction that, when executed, cause the processor to:
receive attendee identity data indicating the identity of one or more selected trade show attendees among the plurality of a trade show attendees; and
correlate the attendee identity data according to one or more selected attendee categories among a predetermined set of attendee categories.

12. The computer product of claim 11 further comprising instruction that, when executed, cause the processor to:
determine a level of interest in one or more selected exhibit categories among the set of exhibit categories based on the correlated attendee data.

13. The computer product of claim 10 further comprising instruction that, when executed, cause the processor to:
receive seminar information indicating seminars attended by one or more selected trade show attendees among the plurality of trade show attendees during a trade show; and
correlate the seminar information according to one or more selected seminar categories among the predetermined set of seminar categories.

14. The computer product of claim 13 further comprising instruction that, when executed, cause the processor to:
determine a level of interest in one or more selected seminar categories among the set of seminar categories based on the received seminar information indicating seminars attended by one or more selected trade show attendees among the plurality of trade show attendees.
